(19) United States
(12) Patent Application Publication
(10) Pub. No.: US 2026/0254065 A1
(43) Pub. Date: Aug. 27, 2026

(54) CASE FOR SECONDARY BATTERY, SECONDARY BATTERY INCLUDING CASE, AND METHOD FOR MANUFACTURING SECONDARY BATTERY

(71) Applicant: SAMSUNG SDI CO., LTD., Yongin-si (KR)

(72) Inventors: Dong Bok YANG, Yongin-si (KR); Cheonsoo KIM, Yongin-si (KR); Junsik KIM, Yongin-si (KR); Junghyun LEE, Yongin-si (KR); Jung Sup KWAK, Yongin-si (KR)

(21) Appl. No.: 19/541,936

(22) Filed: Feb. 17, 2026

(30) Foreign Application Priority Data
Feb. 21, 2025 (KR) 10-2025-0022653

(51) Int. Cl. H01M 50/55; H01M 50/103; H01M 50/105; H01M 50/553

(52) U.S. Cl. CPC H01M 50/55; H01M 50/103; H01M 50/105; H01M 50/553; H01M 2220/20

(57) ABSTRACT

A case for a secondary battery includes a body having an opening at one end and a receiving space configured to accommodate an electrode assembly, and a cover configured to be coupled to the opening and configured to seal the receiving space, wherein the body or the cover includes a dimple, and wherein the dimple protrudes outwardly from the body or the cover.

### CROSS-REFERENCE TO RELATED APPLICATION

This application claims priority to and the benefit of Korean Patent Application No. 10-2025-0022653, filed on February 21, 2025, in the Korean Intellectual Property Office, the entire disclosure of which is incorporated herein by reference.

### BACKGROUND

### TECHNICAL FIELD

The present disclosure relates to a case for a secondary battery, a secondary battery, and a method for manufacturing a secondary battery.

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

The case of a secondary battery, frequently used in small electronic devices, is generally made of a metallic material such as an aluminum alloy. Despite being made of a metallic material, the case may be damaged for various reasons.

Meanwhile, a battery having a relatively high energy density (the amount of energy that can be stored per unit volume) can provide relatively longer run-time for portable devices or relatively longer driving distance for electric vehicles. That is, performance of the secondary battery relies on the energy density. To achieve excellent performance, the case is configured to have minimum space required to accommodate the electrode assembly.

When injecting the electrolyte inside the case, an overflow of the electrolyte may happen due to the limited space. Such an overflow may cause poor welding of an injection-hole pin and exposure of the electrolyte to external contamination.

This Background section is for the general understanding of the background of the present disclosure, and therefore, it may contain information that does not constitute related (or prior) art.

### SUMMARY

The present disclosure provides a case for a secondary battery, a secondary battery, and a method for manufacturing a secondary battery.

Embodiments of the present disclosure provide a case for a secondary battery including a body includes an opening at one end and a receiving space configured to accommodate an electrode assembly, a cover coupled to the opening and configured to seal the receiving space, and a dimple formed on at least one of the body and the cover, wherein the dimple protruding outwardly from the body or the cover in a direction away from the receiving space.

Embodiments of the present disclosure provide a case for a secondary battery including: a body including an opening at one end and a receiving space configured to accommodate an electrode assembly; and a cover configured to be coupled to the opening and configured to seal the receiving space; wherein the body or the cover includes a dimple, and wherein the dimple protrudes outwardly from the body or the cover.

In some embodiments, the body may include a body base including a bottom portion having the dimple formed thereon, and a sidewall portion extending vertically from the bottom portion, and a body flange extending outwardly from the body base and coupled to the cover.

In some embodiments, the body further includes: a body base including a bottom portion including the dimple and a sidewall portion extending vertically from the bottom portion; and a body flange extending outwardly from the body base and configured to be coupled to the cover

In some embodiments, a protrusion depth of the dimple may be from about 0.1% to about 20% of a distance between the bottom portion and the body flange.

In some embodiments, the dimple may be disposed spaced apart from an inner edge of the body flange adjacent to the receiving space.

In some embodiments, the dimple is spaced apart from an inner edge of the body flange.

In some embodiments, an area of the dimple, in a planar view, may be from about 30% to about 50% of an area of the bottom portion.

In some embodiments, a planar area of the dimple is from about 30% to about 50% of a planar area of the bottom portion.

In some embodiments, the dimple, in a planar view, may be formed in one of a circular geometry, a polygonal geometry, a curved polygonal geometry, and a trapezoidal geometry.

In some embodiments, the dimple has a circular geometry, a polygonal geometry, a curved polygonal geometry, or a trapezoidal geometry.

In some embodiments, the dimple may be formed continuously in multiple stages having different planar areas, the planar areas decreasing with increasing distance from the bottom portion.

In some embodiments, the dimple has multiple stages.

In some embodiments, the body and the cover may be composed of a same metallic material.

In some embodiments, the body and the cover include a same metallic material.

In some embodiments, the metallic material may include stainless steel.

In some embodiments, the same metallic material is stainless steel.

In some embodiments, a thickness of the body or the cover may be from about 50 μm to about 100 μm.

Embodiments of the present disclosure provide a secondary battery including an electrode assembly including a first electrode, a separator, and a second electrode, a body including an opening at one end and a receiving space configured to accommodate the electrode assembly and an electrolyte, a cover coupled to the opening and configured to seal the receiving space, and a dimple formed on at least one of the body or the cover, wherein the dimple protruding outwardly from the body or the cover in a direction away from the receiving space.

Embodiments of the present disclosure provide a secondary battery including: an electrode assembly including a first electrode, a separator, and a second electrode; a body including an opening at one end and a receiving space accommodating the electrode assembly and an electrolyte; and a cover coupled to the opening and sealing the receiving space; and wherein the body or the cover includes a dimple, and wherein the dimple protrudes outwardly from the body or the cover.

In some embodiments, the dimple may accommodate the electrolyte.

In some embodiments, the body may include a body base including a bottom portion having the dimple formed thereon, and a sidewall portion extending vertically from the bottom portion, and a body flange extending outwardly from the body base and coupled to the cover.

In some embodiments, the body further includes: a body base including a bottom portion including the dimple and a sidewall portion extending vertically from the bottom portion; and a body flange extending outwardly from the body base and coupled to the cover.

In some embodiments, a protrusion depth of the dimple may be from about 0.1% to about 20% of a distance between the bottom portion and the body flange.

Embodiments of the present disclosure provide a method for manufacturing a secondary battery including preparing a body including a receiving space for an electrode assembly and a cover having a planar shape, forming a dimple on at least one of the body and the cover, the dimple protruding outwardly from the body or the cover in a direction away from the receiving space, inserting the electrode assembly through an opening of the body, coupling the cover to the opening of the body, and injecting an electrolyte into the body through an injection hole formed on one side of the body.

Embodiments of the present disclosure provide a method for manufacturing a secondary battery, including: preparing a body and a cover, the body including a receiving space to accommodate an electrode assembly; forming a dimple on the body or the cover, the dimple protruding outwardly from the body or the cover; accommodating the electrode assembly through an opening of the body; coupling the cover to the opening; and injecting an electrolyte into the body through an injection hole formed on one side of the body.

In some embodiments, the preparing of the body may include forming a body base including a bottom portion and a sidewall portion extending vertically from the bottom portion, and forming a body flange extending outwardly from the body base and configured to be coupled to the cover.

In some embodiments, the preparing includes: preparing a body base comprising a bottom portion and a sidewall portion, the sidewall portion extending vertically from the bottom portion; and preparing a body flange extending outwardly from the body base and configured to be coupled to the cover.

In some embodiments, the forming of the dimple may include forming a protrusion depth of the dimple in a range of about 0.1% to about 20% of a distance between the bottom portion and the body flange.

In some embodiments, a protrusion depth of the dimple is from about 0.1% to about 20% of a distance between the bottom portion and the body flange.

In some embodiments, the forming of the dimple may include forming an area of the dimple, in a planar view, in a range of about 30% to about 50% of an area of the bottom portion.

In some embodiments, a planar area of the dimple is from about 30% to about 50% of a planar area of the bottom portion.

In some embodiments, the forming of the dimple may include continuously forming the dimple in multiple stages having different planar areas, the planar areas decreasing with increasing distance from the bottom portion.

In some embodiments, the forming comprises forming the dimple to have multiple stages.

In some embodiments, the injecting of the electrolyte may include accommodating, in the dimple, the electrolyte that is not impregnated into the electrode assembly.

In some embodiments, the injecting comprises accommodating the electrolyte in the dimple.

According to various embodiments of the present disclosure, the formation of the dimple on at least one of the body and the cover may provide a space into which the electrolyte, not impregnated into the electrode assembly, can move. Accordingly, an overflow phenomenon that would otherwise occur because a space for injecting the electrolyte is insufficient can be prevented, and welding defects of an injection-hole pin and contamination of the electrolyte can be suppressed.

According to various embodiments of the present disclosure, by disposing the dimple spaced apart from a welded region between the cover and the body, movement of the electrolyte toward the injection-hole side and the welded region between the body and the cover can be prevented. Therefore, while preventing welding defects, it is possible to maintain the size of an internal space of the case in which the electrode assembly is disposed. As a result, deformation caused by movement of the electrode assembly due to a drop or the like can be prevented, a fire accident caused by a short can be avoided, and the safety of the secondary battery can be improved.

### BRIEF DESCRIPTION OF THE DRAWINGS

The drawings illustrate embodiments of the present disclosure, and further describe aspects and features of the present disclosure together with the detailed description of the present disclosure. Thus, the present disclosure should not be construed as being limited to the drawings.

FIG. 1 is an exploded perspective view illustrating a secondary battery according to embodiments of the present disclosure.

FIG. 2 is a perspective view illustrating a secondary battery according to embodiments of the present disclosure.

FIG. 3 is an exploded perspective view illustrating a case for a secondary battery according to embodiments of the present disclosure.

FIG. 4 is a cross-sectional view taken along line A-A′ of FIG. 3 in which a dimple is formed on the body.

FIG. 5 is a cross-sectional view taken along line A-A′ of FIG. 3 in which a dimple is formed on the cover.

FIG. 6 is a cross-sectional view taken along line A-A′ of FIG. 3 in which dimples are formed on both the body and the cover.

FIG. 7 is a cross-sectional view illustrating a secondary battery, according to embodiments of the present disclosure, in which a dimple is formed on the body.

FIG. 8 is a cross-sectional view illustrating a secondary battery, according to embodiments of the present disclosure, in which a dimple is formed on the cover.

FIG. 9 is a plan view of the body, according to embodiments of the present disclosure, illustrating an area of the dimple in a planar view.

FIG. 10 is a cross-sectional view illustrating a secondary battery, according to embodiments of the present disclosure, in which the dimple is formed in multiple stages on the body.

FIG. 11 is a plan view of the body, according to embodiments of the present disclosure, illustrating an area of the dimple of FIG. 10 in a planar view.

FIG. 12 is a diagram, in a planar view, illustrating geometries of the dimple according to embodiments of the present disclosure.

FIG. 13 is a flowchart illustrating a method for manufacturing a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terminology used herein is for the purpose of describing embodiments of the present disclosure and is not intended to be limiting of the present disclosure.

Throughout the specification, when a part is described as including a certain element, the description means that the part may further include another element unless the context clearly indicates otherwise.

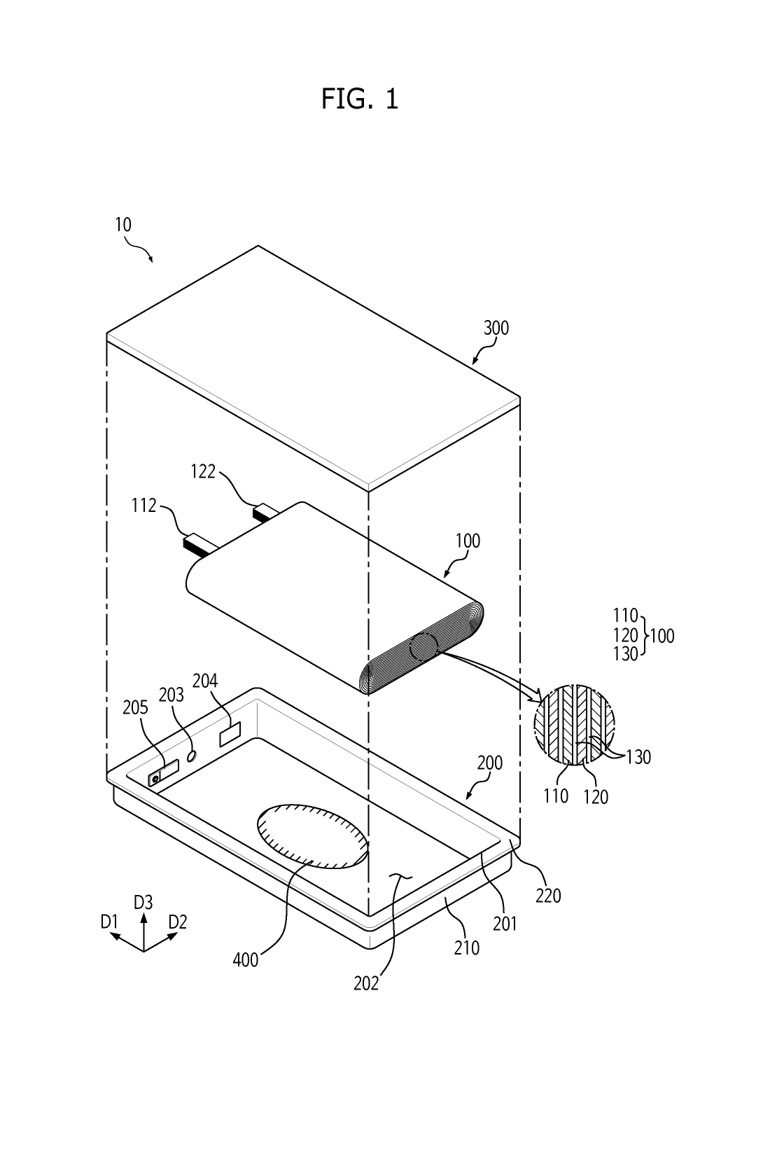

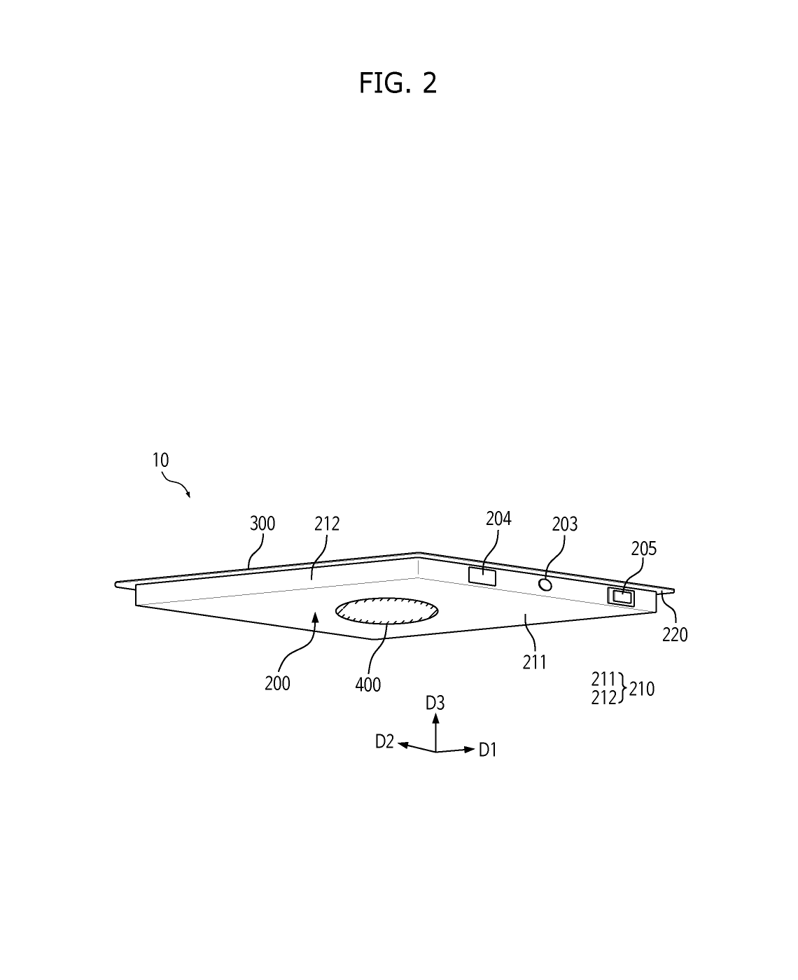

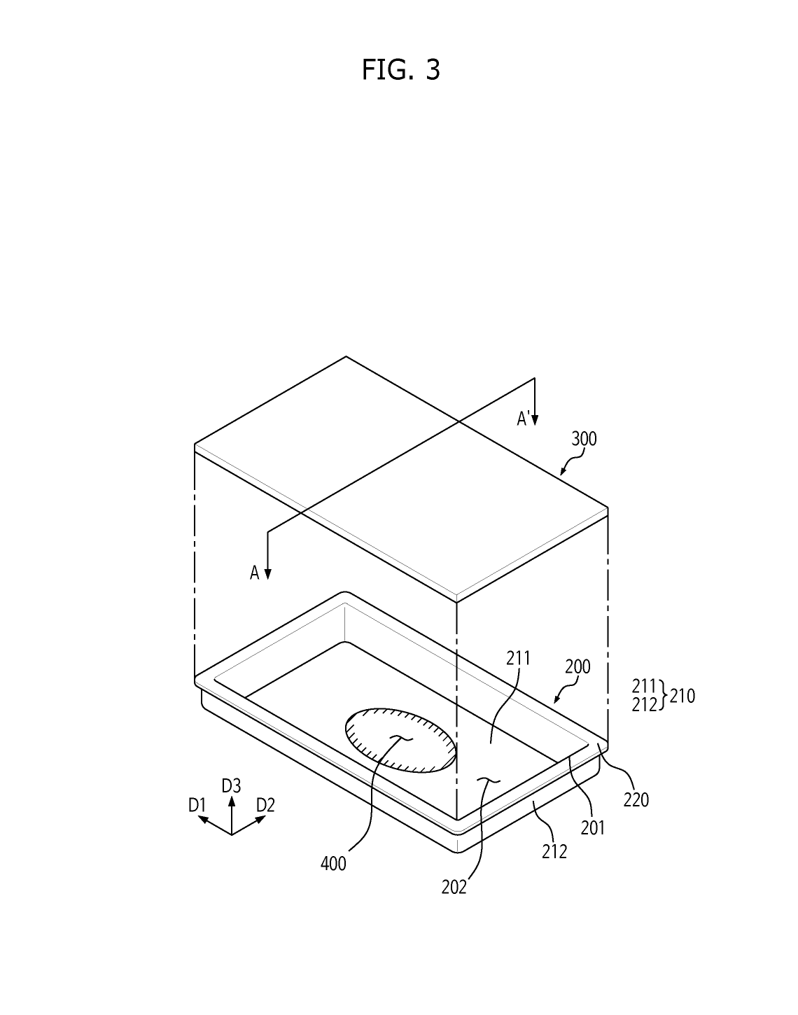

FIG. 1 is an exploded perspective view illustrating a secondary battery. FIG. 2 is a perspective view illustrating a secondary battery. FIG. 3 is an exploded perspective view illustrating a case for a secondary battery.

Referring to FIGS. 1 through 3, a secondary battery 10 may include an electrode assembly 100, a body 200 defining a receiving space 202 that accommodates the electrode assembly 100, a cover 300 coupled to the body 200, and a dimple 400 formed on at least one of the body 200 and the cover 300. The dimple 400 may protrude outwardly from the body 200 or the cover 300 in a direction away from the receiving space 202. Accordingly, the dimple 400 provides a space in which an electrolyte (not shown) that is not impregnated into the electrode assembly 100 can move, thereby preventing an overflow of the electrolyte.

The electrode assembly 100 may include a first electrode 110, a separator 130, and a second electrode 120. For example, the electrode assembly 100 may be wound or stacked with the separator 130 interposed between the first electrode 110 and the second electrode 120. The first electrode 110 may include a first current collector and a first active-material layer disposed on the first current collector. A first electrode tab 112 may extend outwardly from a first non-coated region of the first current collector on which the first active-material layer is not disposed. The second electrode 120 may include a second current collector and a second active-material layer disposed on the second current collector. A second electrode tab 122 may extend outwardly from a second non-coated region of the second current collector on which the second active-material layer is not disposed.

The first electrode 110 may function as a positive electrode. In this manner, the first current collector may be a positive-electrode current collector. The positive-electrode current collector may include an aluminum foil, and the positive-electrode active material may include, for example, a transition-metal oxide.

The positive electrode active material may include a compound (e.g., a lithiated intercalation compound) that is capable of intercalating and deintercalating lithium. Specifically, at least one of a composite oxide of lithium and a metal including cobalt, manganese, nickel, or combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA₁-bX_{b}O₂-cD_{c} (0.90≤a≤1.8, 0≤b≤0.5, and 0≤c≤0.05); LiₐMn₂-bX_{b}O₄-cD_{c} (0.90≤a≤1.8, 0≤b≤0.5, and 0≤c≤0.05); LiₐNi_{1-b-c}Co_{b}X_{c}O₂-αD_{α} (0.90≤a≤1.8, 0≤b≤0.5, 0≤c≤0.5, and 0<α<2); LiₐNi_{1-b-c}Mn_{b}X_{c}O₂-αD_{α} (0.90≤a≤1.8, 0≤b≤0.5, 0≤c≤0.5, and 0<α<2); LiₐNi_{b}Co_{c}L1_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing relatively high capacity and can be applied to a relatively high-capacity, relatively high-density rechargeable lithium battery.

The second electrode 120 may function as a negative electrode. In this manner, the second current collector may be a negative-electrode current collector. The negative-electrode current collector may include, for example, a copper foil or a nickel foil, and the negative-electrode active material may include, for example, graphite.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, for example, crystalline carbon, amorphous carbon, or a combination thereof. The crystalline carbon may be graphite being a non-shaped, sheet-shaped, flake-shaped, sphere-shaped, or fiber-shaped natural graphite or artificial graphite. The amorphous carbon may be a soft carbon, a hard carbon, a mesophase pitch carbonization product, or calcined coke.

The lithium metal alloy includes an alloy of lithium and a metal including Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si-based negative electrode active material or a Sn-based negative electrode active material. The Si-based negative electrode active material may include silicon, a silicon-carbon composite, SiOₓ (0 < x < 2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. The silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayer film of two or more layers thereof, or a mixed multilayer film such as a polyethylene/polypropylene two-layer separator, polyethylene/polypropylene/polyethylene three-layer separator, polypropylene/polyethylene/polypropylene three-layer separator.

The separator may include a porous substrate and a coating layer including an organic material, an inorganic material, or a combination thereof on one or both surfaces of the porous substrate.

The porous substrate may be a polymer film including a polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The body 200 may have an opening 201 formed at one end (for example, at an end of the body 200 in the D3 direction). The body 200 is open at the end where the opening 201 is formed, so that the electrode assembly 100 can be accommodated. The body 200 defines/forms the receiving space 202 that accommodates the electrode assembly 100.

The body 200 may include a body base 210 and a body flange 220. The body 200 may include the body base 210 and a body flange 220 that extends outwardly from the body base 210 and that is coupled to the cover 300. The body base 210 may include a bottom portion 211 and a sidewall portion 212 that extends in a vertical direction from the bottom portion 211. The bottom portion 211 may be polygonal, and a plurality of sidewall portions 212 corresponding to respective sides (edges) of the polygonal bottom portion 211 may be formed.

The bottom portion 211 of the body base 210 may have any geometry. For example, the bottom portion 211 may have a rectangular geometry. In that manner, the sidewall portion 212 may surround the four sides of the rectangular bottom portion 211. The bottom portion 211 may have a circular geometry. In that manner, the sidewall portion 212 may surround the circumference of the circular bottom portion 211.

The sidewall portion 212 may be bent and extend from the bottom portion 211. For example, the sidewall portion 212 may be bent and extend from the bottom portion 211 in the D3 direction. The sidewall portion 212 may surround the bottom portion 211. The sidewall portion 212 may have four walls extending from the bottom portion 211 in the D3 direction. A negative-electrode terminal 204 and a positive-electrode terminal 205 may be disposed on at least one surface of the sidewall portion 212.

A receiving space 202 that accommodates the electrode assembly 100 may be located in a substantially central region of the body 200 by a press-working or drawing process. The body flange 220 may be configured to have four directions at an upper rim of the receiving space 202. The body flange 220 may extend outwardly from the body base 210 and may be coupled to the cover 300. The electrode assembly 100 may be inserted into the receiving space 202 through the opening 201 of the body 200. The cover 300 may be coupled to the opening 201 of the body 200 and may seal the receiving space 202.

The negative-electrode terminal 204 and the positive-electrode terminal 205 may be disposed on a side surface of the body 200 that is different from the open surface (for example, on a surface of the body 200 in the D1 direction). The body 200 may include an injection hole 203. For example, the injection hole 203 may be a through-hole formed in a side surface of the body 200. After the body 200 and the cover 300 are joined and sealed, the injection hole 203 may be used to inject the electrolyte into the interior of the body 200 of the secondary battery 10.

After the electrolyte is injected, the injection hole 203 may be sealed by a sealing member. While the injection hole 203 is illustrated as being located between a pair of electrode terminals, the present disclosure is not limited thereto and may have various modifications. A pair of electrode terminals may be disposed on the side surface of the body 200. For example, the negative-electrode terminal 204 and the positive-electrode terminal 205 may be disposed on both sides in the D2 direction with respect to the injection hole 203.

The positive-electrode terminal 205 may be electrically connected to the first electrode tab 112 of the electrode assembly 100, and the negative-electrode terminal 204 may be electrically connected to the second electrode tab 122 of the electrode assembly 100. The positions of the positive-electrode terminal 205 and the negative-electrode terminal 204 are not limited to the positions shown in FIG. 1 and may have various modifications.

The cover 300 may be coupled to the open surface of the body 200. For example, the cover 300 may be coupled to the opening 201 and may seal the receiving space 202. The body 200 and the cover 300 may be joined to define an exterior appearance of the secondary battery 10. For example, the cover 300 may be formed as a plate disposed atop the body 200 so as to seal the receiving space 202 of the body 200. The cover 300 may be formed as a plate having a size sufficient to cover the body flange 220 and may make surface contact with the body flange 220.

At least a portion of the body flange 220 may be joined to the cover 300 by laser welding. For example, the body 200 and the cover 300 may be joined by metal bonding (e.g., welding, brazing, or soldering). In this manner, an edge of the body flange 220 and an edge of the cover 300 may be joined. After the body 200 and the cover 300 are joined, at least a portion of the body flange 220 may be cut using a laser improving an energy density of the secondary battery 10.

While the body 200 having the body flange 220 is illustrated in the drawings, the present disclosure is not limited thereto. The body 200 may be coupled to the cover 300 without the body flange 220.

The body 200 and the cover 300 may be joined via a separate adhesive layer. The adhesive layer may include a hot-melt adhesive or rubber. For example, the hot-melt adhesive may include, but is not limited to, an acrylic-based resin, a synthetic-rubber-based resin, a polyolefin-based resin, an ester-based resin, a urethane-based resin, an epoxy-based resin, or a silicone-based resin. By applying a molten hot-melt adhesive melt to a film layer or by impregnating the film layer with a hot-melt adhesive solution obtained by dissolving the hot-melt adhesive in a solvent and then volatilizing the solvent, the film may be impregnated with the hot-melt adhesive. However, the present disclosure is not limited thereto, and various impregnation methods of the hot-melt adhesive may be used.

The joining method of the body 200 and the cover 300 is not limited to the joining types described in the present disclosure, and various methods may be used at the choice of a person having ordinary skill in the art.

At least one of the body 200 and the cover 300 may include stainless steel, including stainless use steel (SUS). For example, the body 200 and the cover 300 illustrated in FIG. 1 may include SUS, such that the secondary battery 10 may be an SUS-can-type secondary battery. However, the present disclosure is not limited thereto. For example, the body 200 and the cover 300 may include a conductive metal such as aluminum, an aluminum alloy, or nickel-plated steel defining an overall exterior appearance of the secondary battery 10.

The body 200 and the cover 300 may include the same metallic material. By forming the body 200 and the cover 300 of the same material, corrosion at the regions where the body 200 and the cover 300 are joined can be prevented. The metallic material that forms the body 200 and the cover 300 may include stainless steel material. Depending on the type and proportion of alloying constituents within a stainless-steel family, the stainless-steel material may be selected as any type such as SUS 304, SUS 316, SUS 420, or SUS 430.

The secondary battery 10 may be, for example, a lithium battery cell or a sodium battery cell. However, the scope of the present disclosure is not limited thereto, and the secondary battery 10 may encompass all types of batteries that are capable of repeatedly supplying electric power by charging and discharging. A secondary battery 10 can be a lithium secondary battery, , and can be used in an electric vehicle (EV) due to excellent cycle characteristics and relatively high-rate characteristics. For example, it can be used in a plug-in hybrid electric vehicle (PHEV). Furthermore, the lithium secondary battery can be used in fields requiring power storage over a wide range. For example, it can be used in a smart phone, a tablet PC, an electric bicycle, or a power tool.

Configurations other than those illustrated in the present disclosure may additionally be included, or some configurations may be omitted. The geometries and positional relationships of the respective configurations of the secondary battery illustrated in FIG. 1 may be appropriately changed. D1, D2, and D3 shown in FIG. 1 may respectively indicate a longitudinal direction, a lateral direction, and a vertical direction of the secondary battery 10 or of a configuration of the secondary battery 10 (for example, the body 200 or the electrode assembly 100).

The dimple 400 may be formed on at least one of the body 200 and the cover 300. For example, the dimple 400 may protrude outwardly from the body 200 in a direction away from the receiving space 202. The dimple 400 may protrude outwardly from the bottom portion 211 of the body 200 in the D3 direction. The dimple 400 may be formed so as to accommodate the electrolyte.

The dimple 400 may be formed on the bottom portion 211. The body 200 may be formed by a drawing/press process such that the body base 210 includes the bottom portion 211 and the sidewall portion 212 and the body flange 220. After the body 200 is drawing/press-formed, the body base 210 may define the receiving space 202 that accommodates the electrode assembly 100. The dimple 400 may be formed during the drawing/press-forming process of the body 200. For example, the dimple 400 may be formed in a substantially central region of the bottom portion 211 during the drawing/press-forming process of the body 200.

the dimple 400 may protrude outwardly from the bottom portion 211 in the D3 direction by a predetermined depth. The dimple 400 may be a space in which the electrolyte accommodated within the receiving space 202 moves. The dimple 400 may be configured to accommodate the electrolyte in which the cover 300 is coupled to the opening 201 of the body 200. By protruding from the bottom portion 211, the dimple 400 may provide a space in which the electrolyte, not being impregnated into the electrode assembly 100, can move. Accordingly, an overflow of the electrolyte within the secondary battery 10 can be prevented.

In a comparative example in which the dimple 400 is not formed on the body 200 or the cover 300, an overflow may occur in which the electrolyte, not impregnated into the electrode assembly 100 during electrolyte injection, leaks out through the injection hole 203. If an injection-hole pin, which is a sealing member, is then welded to the injection hole 203, welding defects may occur. Accordingly, there is a risk that the electrolyte is exposed to external contaminants.

To prevent overflow, the areas of the bottom portion 211 and the sidewall portion 212 are increased such that the receiving space 202 increases and the electrode assembly 100 may move upward/downward or sideways, thereby causing leakage. When the electrode assembly 100 moves within the internal space of the body 200, cracks may occur in the electrode plates, and stability of the secondary battery cannot be ensured. The energy density relative to the overall size of the secondary battery may be reduced.

The dimple 400 may be spaced apart from an inner edge of the body flange 220 that is adjacent to the receiving space 202. For example, after the drawing process of the body 200 is completed, the body 200 is coupled to the cover 300, and it may be necessary to secure a region to be welded to the cover 300. The inner edge of the body flange 220 that is adjacent to the receiving space 202 may be close to a region where the body 200 and the cover 300 are welded and may represent one end of the body flange 220 that is close to the injection hole 203.

According to a comparative example, when the dimple 400 is disposed adjacent to the inner edge of the body flange 220 that is adjacent to the receiving space 202, the dimple 400 may fail to hold the electrode assembly 100 against movement in the D3 direction. When the dimple 400 is formed at a position adjacent to the injection hole 203, the electrolyte, not capable of moving into the dimple 400, may overflow through the injection hole 203.

The dimple 400 may be spaced apart from the inner edge of the body flange 220 that is adjacent to the receiving space 202. While the bottom portion 211 restrains the electrode assembly 100 from moving in the D3 direction, the electrolyte moves into the dimple 400, thereby preventing overflow.

That is, the dimple 400 may be formed at a substantially central region of the bottom portion 211, spaced apart from the injection hole 203, and may guide the electrolyte, not being impregnated into the electrode assembly 100, to move. When the electrolyte moves into the dimple 400 during the electrolyte-injecting process, electrolyte inside the receiving space 202 does not leak through the injection hole 203, preventing overflow. Accordingly, exposure of the electrolyte to external contaminants may be prevented.

In some embodiments, the spacing distance in the D1 direction, that is, the distance between the outer edge of the internal body of the bottom portion 211 and the proximal edge of the dimple 400 in the D1 direction, is at least about 5% of the internal body length along the D1 direction. In some embodiments, the spacing distance in the D2 direction, that is, the distance between the outer edge of the internal body of the bottom portion 211 and the proximal edge of the dimple 400 in the D2 direction, is at least about 5% of the internal body length along the D2 direction.

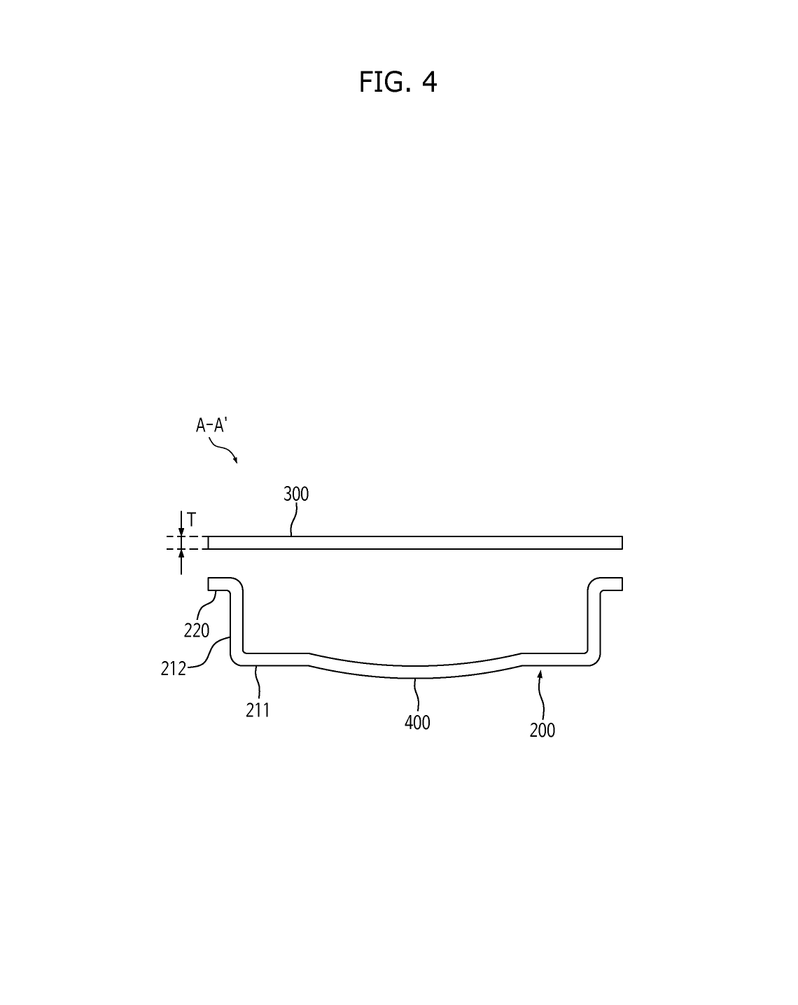

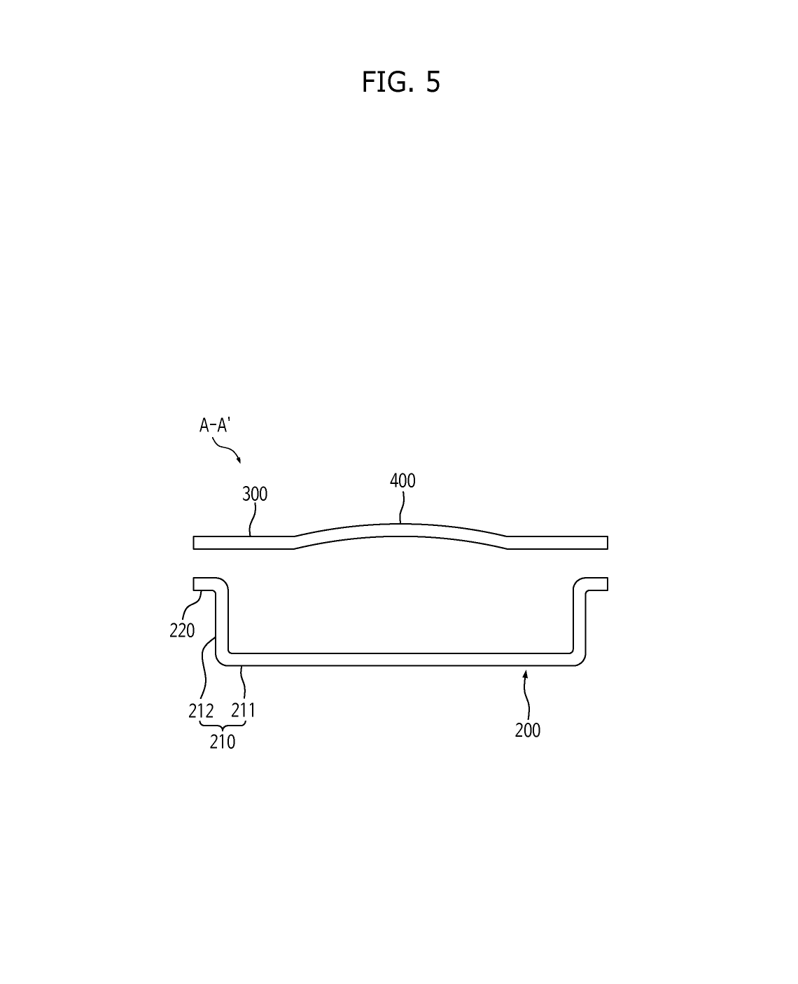

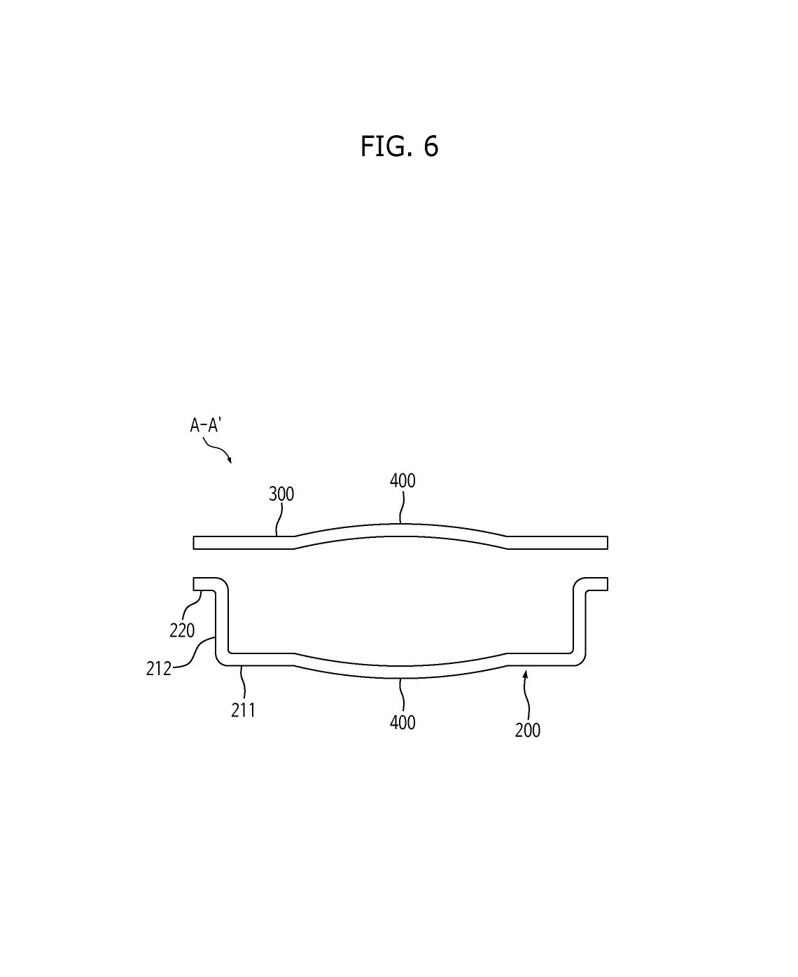

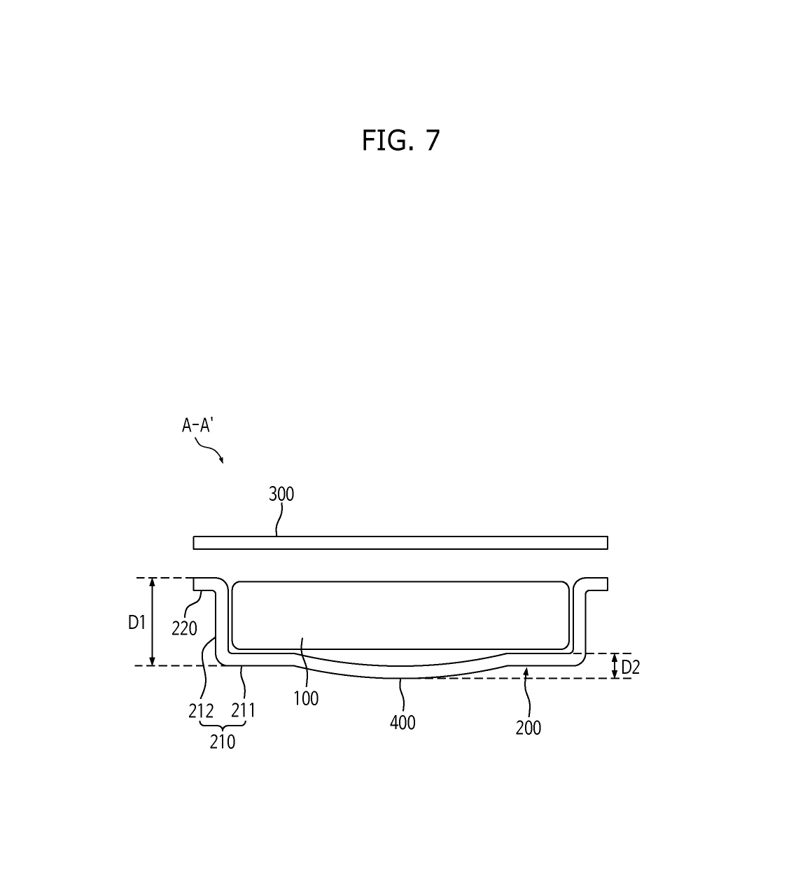

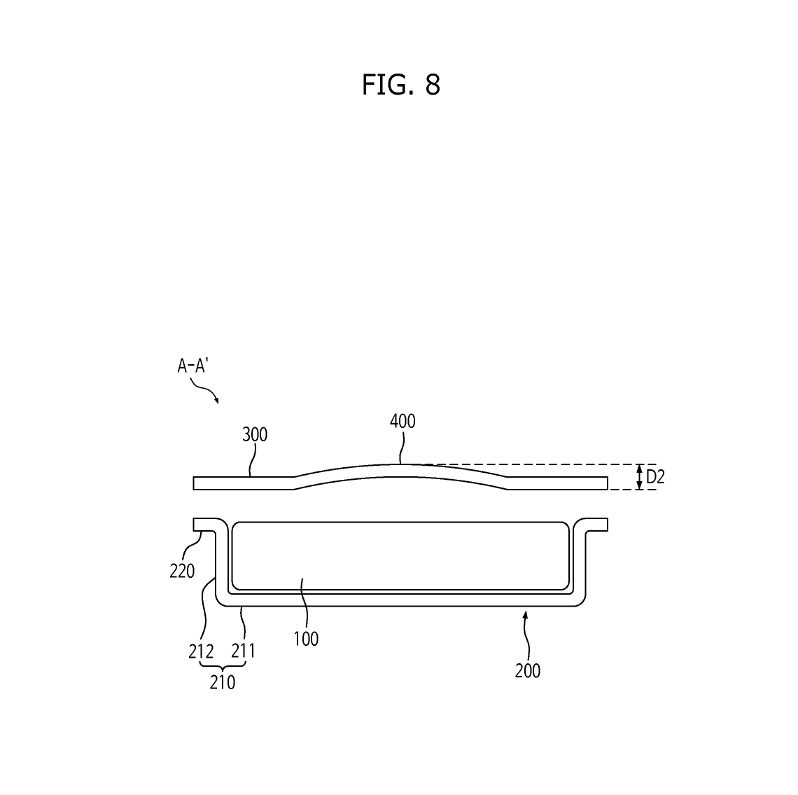

FIG. 4 is a cross-sectional view taken along line A-A′ of FIG. 3 in which a dimple is formed on the body. FIG. 5 is a cross-sectional view taken along line A-A′ of FIG. 3 in which a dimple is formed on the cover. FIG. 6 is a cross-sectional view taken along line A-A′ of FIG. 3 in which dimples are formed on both the body and the cover. FIG. 7 is a cross-sectional view illustrating a secondary battery in which a dimple is formed on the body. FIG. 8 is a cross-sectional view illustrating a secondary battery in which a dimple is formed on the cover.

A case for a secondary battery may include the body 200, the cover 300, and the dimple 400 formed on at least one of the body 200 and the cover 300. The body 200 may be formed by a drawing/press-forming process including the body base 210 and the body flange 220, and the body base 210 may include the bottom portion 211 and the sidewall portion 212. The body base 210 may define a receiving space that accommodates the electrode assembly 100.

A thickness T of the body 200 and/or the cover 300 may be from about 50 µm to about 100 µm. The body 200 or the cover 300 may include stainless steel. The secondary battery may be an SUS-can-type secondary battery; however, the present disclosure is not limited thereto.

Referring to FIG. 4, the dimple 400 may be formed on the body 200, and the cover 300 may have a planar geometry. The dimple 400 may protrude outwardly from the body 200 in a direction away from the receiving space to accommodate the electrolyte. The dimple 400 may be formed in a substantially central region of the bottom portion 211 during the drawing/press-forming process of the body 200. When the cover 300 is coupled to the body 200, the planar cover 300 may support an upper surface of the electrode assembly to prevent movement of the electrode assembly. When the electrolyte is injected into the receiving space of the body 200, electrolyte that is not impregnated into the electrode assembly may move into the dimple 400, thereby preventing overflow.

Referring to FIG. 5, the dimple 400 may be formed on the cover 300, and the bottom portion 211 may have a planar geometry. The dimple 400 may protrude outwardly from the cover 300 in a direction away from the receiving space to accommodate the electrolyte. The dimple 400 may be formed in a substantially central region of the cover 300 during a drawing/press-forming process of the cover 300. When the cover 300 is coupled to the body 200, the planar bottom portion 211 may support a lower surface of the electrode assembly to prevent movement of the electrode assembly. When the electrolyte is injected into the receiving space of the body 200, electrolyte that is not impregnated into the electrode assembly may move into the dimple 400, thereby preventing overflow.

Referring to FIG. 6, the dimple 400 may be formed on both the body 200 and the cover 300. The dimple 400 may protrude outwardly from the body 200 and the cover 300 in a direction away from the receiving space to accommodate the electrolyte. The dimple 400 may be formed in substantially central regions of the body 200 and the cover 300 during drawing/press-forming processes of the body 200 and the cover 300. When the cover 300 is coupled to the body 200, regions of the bottom portion 211 and the cover 300 where the dimple 400 is not formed may support an upper surface and a lower surface of the electrode assembly to prevent movement of the electrode assembly. When the electrolyte is injected into the receiving space of the body 200, electrolyte that is not impregnated into the electrode assembly may move into the dimple 400, thereby preventing overflow.

Referring to FIGS. 7 and 8, a protrusion depth D2 of the dimple 400 may be from about 0.1 % to about 20 % of a distance D1 between the bottom portion 211 and the body flange 220. The protrusion depth D2 of the dimple 400 is set to provide an accommodating space for the electrolyte without affecting a space in which the secondary battery is mounted in an electronic device. The protrusion depth D2 of the dimple 400 may be measured based on a part of the dimple 400 that protrudes the most.

For example, when the protrusion depth D2 of the dimple 400 is less than about 0.1 % of the distance D1 between the bottom portion 211 and the body flange 220, the dimple 400 may fail to sufficiently perform as a space that accommodates the electrolyte. When the protrusion depth D2 of the dimple 400 exceeds about 20 % of the distance D1 between the bottom portion 211 and the body flange 220, the bottom portion 211 and/or the cover 300 on which the dimple 400 is formed may become vulnerable to physical shock and even small pressure. Moreover, a dead space may be caused in an electronic device in which the secondary battery is mounted. Therefore, the protrusion depth D2 of the dimple 400 is set to function as an accommodating space for the electrolyte without causing a decrease in the strength of the body 200 or the cover 300.

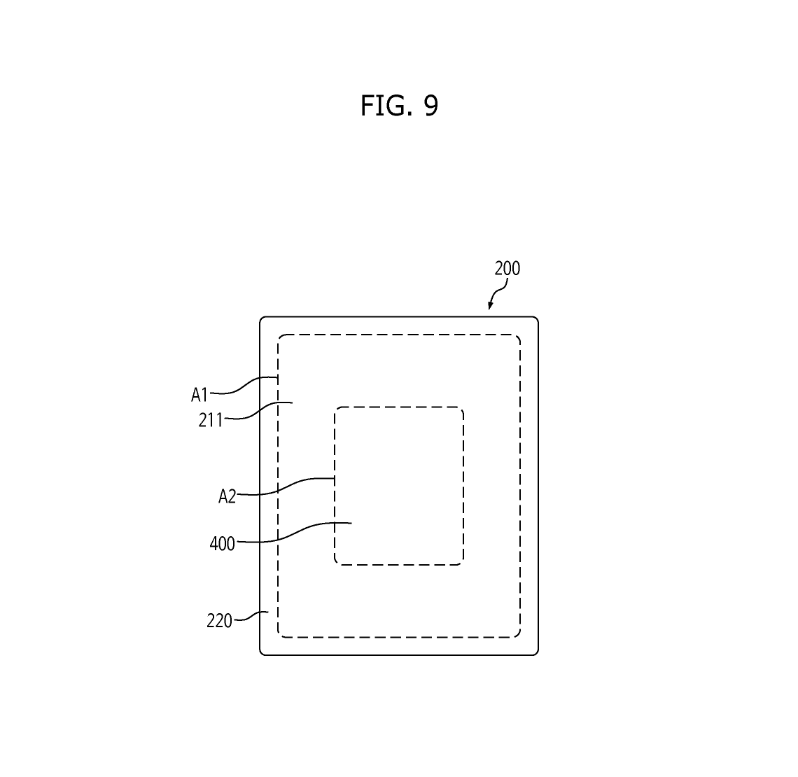

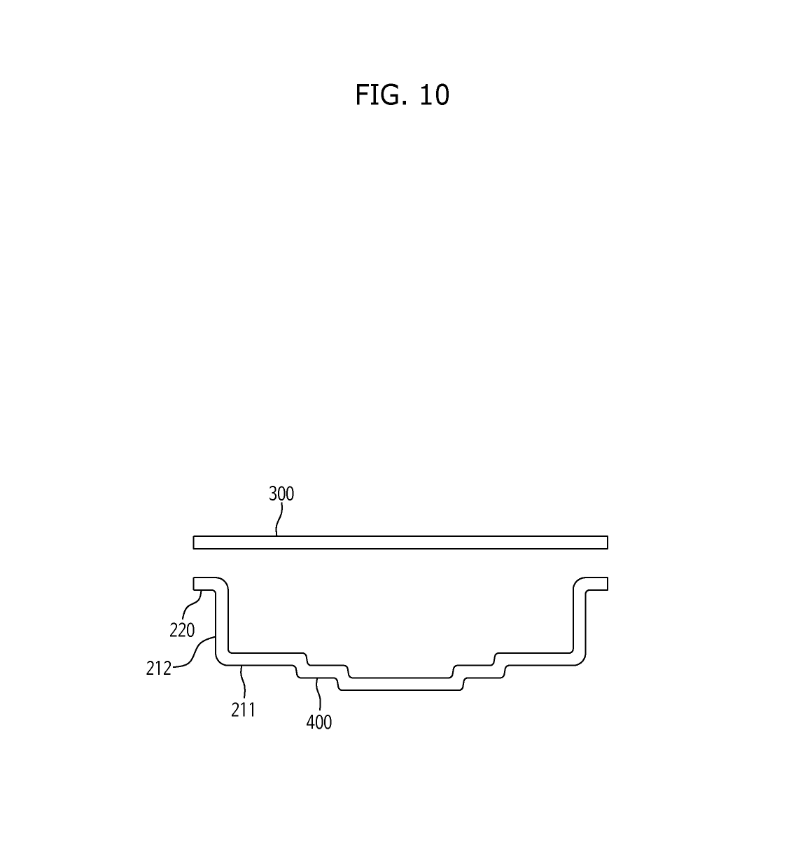

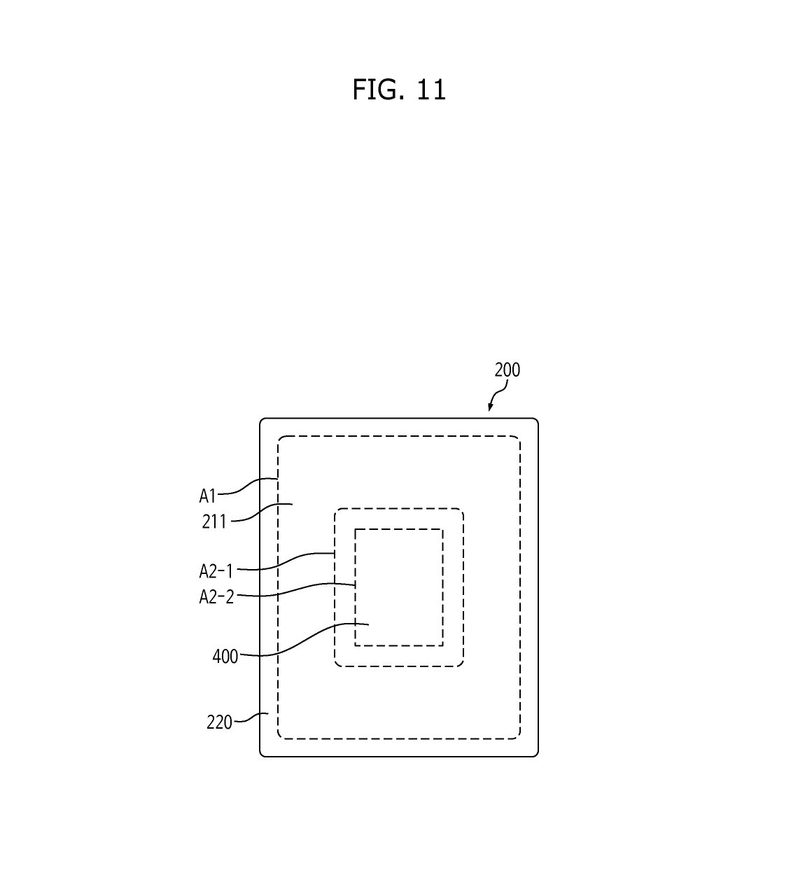

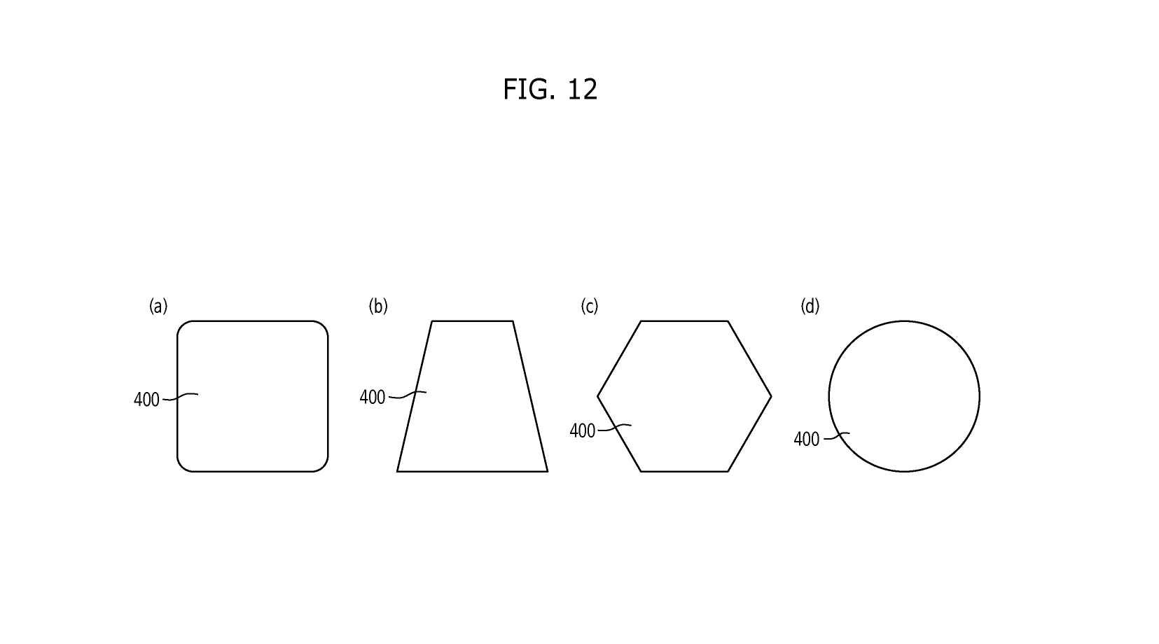

FIG. 9 is a plan view of the body illustrating an area of the dimple in a planar view. FIG. 10 is a cross-sectional view illustrating a secondary battery in which the dimple is formed in multiple stages on the body. FIG. 11 is a plan view of the illustrating an area of the dimple of FIG. 10 in a planar view. FIG. 12 is a diagram, in a planar view, illustrating geometries of the dimple.

Referring to FIGS. 9 through 12, an area A2 of the dimple 400, in a planar view, may be from about 30 % to about 50 % of an area A1 of the bottom portion 211, in a planar view. The area A1 of the bottom portion 211, in a planar view, may refer to an area (dotted line area A1) obtained when the body 200 is projected onto a plane, excluding an area of the body flange 220. In some embodiments, area A1 does not include the body flange 220. The area A2 of the dimple 400, in a planar view, may refer to an area (dotted line areas A2, A2-1, A2-2) corresponding to an outline of the dimple 400 obtained when the body 200 is projected onto a plane. In some embodiments, area A2 can occupy up to about 90% of area A1.

When the electrolyte is injected through the injection hole while the cover 300 is coupled to the body flange 220, the electrolyte that is not impregnated into the electrode assembly may move into the dimple 400 and be accommodated. The area A2 of the dimple 400 is from about 30 % to about 50 % of the area A1 of the bottom portion 211, in a planar view, so that the bottom portion 211 can serve to restrain movement of the electrode assembly 100 while providing a space that accommodates the electrolyte.

That is, an area (A1-A2) of the bottom portion 211 where the dimple 400 is not formed can support one surface of the electrode assembly so as to restrain movement of the electrode assembly. Accordingly, deformation caused by movement of the electrode assembly (e.g., a drop) can be prevented and a fire accident caused by a short can be avoided, thereby improving safety of the secondary battery. The electrolyte that is not impregnated into the electrode assembly can move into and be accommodated within the dimple 400.

The dimple 400 may be formed continuously in multiple stages having different planar areas A2-1 and A2-2 in a planar view. In this manner, the multiple planar areas A2-1 and A2-2 may decrease with increasing distance from the bottom portion 211, with reference to FIG. 10.

The electrolyte, not impregnated into the electrode assembly, may move into the dimple 400 formed in multiple stages (e.g., a multistage dimple) within the receiving space of the body 200 and be accommodated therein. The dimple 400 formed in multiple stages may accommodate the electrolyte that may flow back toward the injection-hole side during electrolyte injection through the injection hole. Accordingly, while preventing injection-hole welding defects, the size of the receiving space can be maintained, and occurrence of movement of the electrode assembly can be suppressed.

The dimple 400, in a planar view, may have a circular geometry, a polygonal geometry, a curved polygonal geometry, or a trapezoidal geometry. For example, as shown in FIG. 12(a), the dimple 400 may have a curved-polygonal geometry in which corners are rounded. As shown in FIG. 12(b), the dimple 400 may have a trapezoidal geometry. As shown in FIG. 12(c), the dimple 400 may have a polygonal geometry such as a hexagonal geometry. As shown in FIG. 12(d), the dimple 400 may have a circular geometry. However, the present disclosure is not limited thereto, and the dimple 400 can be implemented in various geometries such as an elliptical geometry or other geometries as necessary. The geometry of the dimple 400 is not particularly limited as long as the geometry can efficiently accommodate the electrolyte.

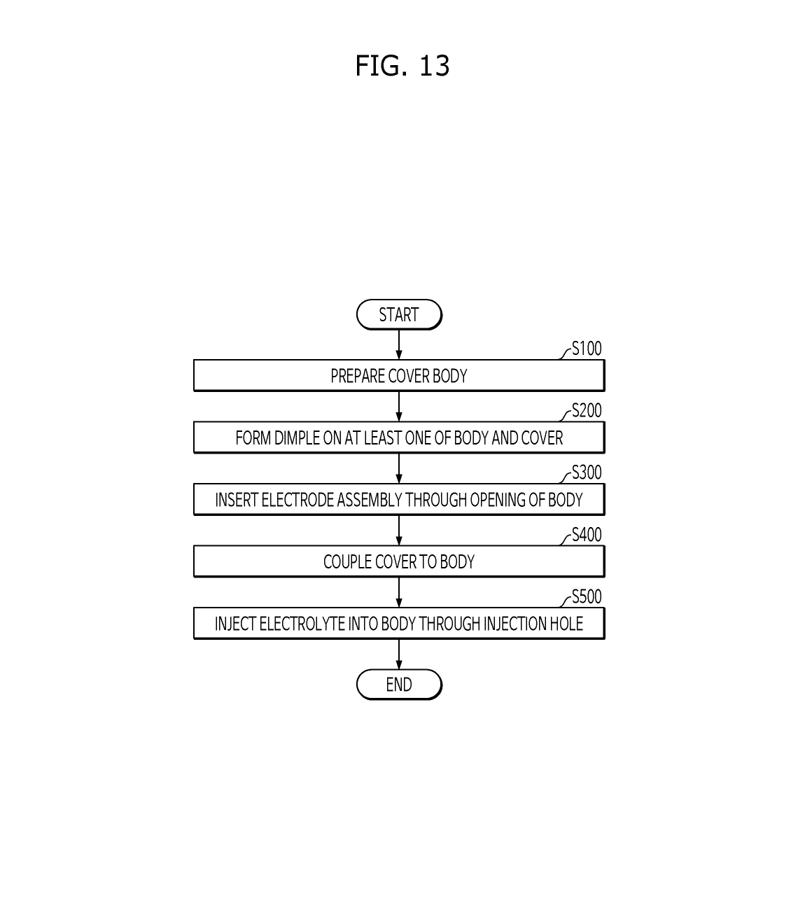

FIG. 13 is a flowchart illustrating a method for manufacturing a secondary battery.

The method for manufacturing a secondary battery may include step S100 of preparing the cover and the body, step S200 of forming a dimple, step S300 of inserting the electrode assembly, step S400 of coupling the cover to the body, and step S500 of injecting the electrolyte into the body.

The step S100 of preparing of the cover and the body may involve preparing the cover having a planar geometry and the body in which a receiving space for the electrode assembly is formed. The step S100 of preparing the body may include forming the body base that includes the bottom portion and the sidewall portion extending in a vertical direction from the bottom portion, and forming the body flange that extends outwardly from the body base and that is coupled to the cover.

The step S200 of forming of the dimple may involve forming, on at least one of the body and the cover, a dimple that protrudes outwardly from the body or the cover in a direction away from the receiving space. The step S200 of forming of the dimple may include forming a protrusion depth of the dimple that is from about 0.1 % to about 20 % of a distance between the bottom portion and the body flange.

In an embodiment, the step S200 of forming of the dimple may include forming an area of the dimple, in a planar view, that is from about 30 % to about 50 % of an area of the bottom portion. The step S200 of forming of the dimple may include continuously forming the dimple in multiple stages having different planar areas in a planar view, and the multiple planar areas may decrease with increasing distance from the bottom portion.

The step S300 of inserting of the electrode assembly may involve inserting the electrode assembly through the opening of the body. After the inserting of the electrode assembly in step S300, step S400 of the coupling of the cover to the body may be performed. The step S400 of coupling the cover to the body may involve coupling the cover to the opening of the body. In step S400 of coupling the cover to the body, the body and the cover may be metal-bonded (for example, welded, brazed, or soldered).

After the coupling of the cover to the body in step S400, step S500 of injecting of the electrolyte into the body may be performed. Injecting the electrolyte into the body in step S500 may involve injecting the electrolyte into the body through an injection hole formed on one side of the body.

The step S500 of injecting of the electrolyte may include accommodating, in the dimple, electrolyte that is not impregnated into the electrode assembly. Electrolyte may be accommodated in the dimple formed in step S200 of the forming of the dimple, and overflow of the electrolyte can be prevented during the injecting of the electrolyte in step S500. By protruding from the bottom portion, the dimple provides a space in which the electrolyte, not impregnated into the electrode assembly, can move during the step of S500 injecting of the electrolyte. Accordingly, overflow of the electrolyte within the secondary battery can be prevented.

The flowchart of FIG. 13 and the foregoing description are merely an example of the present disclosure, and the scope of the present disclosure is not limited to the flowchart of FIG. 13 and the foregoing description. For example, one or more of the steps in the flowchart and the foregoing description may be added, changed, or deleted, an order of one or more of the steps may be changed, or one or more of the steps may be performed simultaneously.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF REPRESENTATIVE REFERENCE NUMERALS

10: secondary battery

100: electrode assembly

200: body

210: body base

211: bottom portion

212: sidewall portion

220: body flange

300: cover

400: dimple

What is claimed is:

1. A case for a secondary battery comprising:
a body comprising an opening at one end and a receiving space configured to accommodate an electrode assembly; and
a cover configured to be coupled to the opening and configured to seal the receiving space;
wherein at least one of the body or the cover includes a dimple, and
wherein the dimple protrudes outwardly from the body or the cover.

2. The case for a secondary battery as claimed in claim 1,
wherein the body further comprises:
a body base comprising a bottom portion including the dimple and a sidewall portion extending vertically from the bottom portion; and
a body flange extending outwardly from the body base and configured to be coupled to the cover.

3. The case for a secondary battery as claimed in claim 2,
wherein a protrusion depth of the dimple is from about 0.1% to about 20% of a distance between the bottom portion and the body flange.

4. The case for a secondary battery as claimed in claim 2,
wherein the dimple is spaced apart from an inner edge of the body flange.

5. The case for a secondary battery as claimed in claim 2,
wherein a planar area of the dimple is from about 30% to about 50% of a planar area of the bottom portion.

6. The case for a secondary battery as claimed in claim 1,
wherein the dimple has a circular geometry, a polygonal geometry, a curved polygonal geometry, or a trapezoidal geometry.

7. The case for a secondary battery as claimed in claim 2,
wherein the dimple has multiple stages.

8. The case for a secondary battery as claimed in claim 1,
wherein the body and the cover include a same metallic material.

9. The case for a secondary battery as claimed in claim 8,
wherein the same metallic material is stainless steel.

10. The case for a secondary battery as claimed in claim 1,
wherein a thickness of the body or the cover is from about 50 μm to about 100 μm.

11. A secondary battery comprising:
an electrode assembly comprising a first electrode, a separator, and a second electrode;
a body comprising an opening at one end and a receiving space accommodating the electrode assembly and an electrolyte; and
a cover coupled to the opening and sealing the receiving space; and
wherein at least one of the body or the cover includes a dimple, and
wherein the dimple protrudes outwardly from the body or the cover.

12. The secondary battery as claimed in claim 11,
wherein the dimple accommodates the electrolyte.

13. The secondary battery as claimed in claim 11,
wherein the body further comprises:
a body base comprising a bottom portion including the dimple and a sidewall portion extending vertically from the bottom portion; and
a body flange extending outwardly from the body base and coupled to the cover.

14. The secondary battery as claimed in claim 13,
wherein a protrusion depth of the dimple is from about 0.1% to about 20% of a distance between the bottom portion and the body flange.

15. A method for manufacturing a secondary battery, comprising:
preparing a body and a cover, the body comprising a receiving space to accommodate an electrode assembly;
forming a dimple on at least one of the body or the cover, the dimple protruding outwardly from the body or the cover;
accommodating the electrode assembly through an opening of the body;
coupling the cover to the opening; and
injecting an electrolyte into the body through an injection hole formed on one side of the body.

16. The method as claimed in claim 15,
wherein the preparing comprises:
preparing a body base comprising a bottom portion and a sidewall portion, the sidewall portion extending vertically from the bottom portion; and
preparing a body flange extending outwardly from the body base and configured to be coupled to the cover.

17. The method as claimed in claim 16,
wherein a protrusion depth of the dimple is from about 0.1% to about 20% of a distance between the bottom portion and the body flange.

18. The method as claimed in claim 16,
wherein a planar area of the dimple is from about 30% to about 50% of a planar area of the bottom portion.

19. The method as claimed in claim 16,
wherein the forming comprises forming the dimple to have multiple stages.

20. The method as claimed in claim 15,
wherein the injecting comprises accommodating the electrolyte in the dimple.
